(19) United States
(12) Patent Application Publication
(10) Pub. No.: US 2026/0119399 A1
(43) Pub. Date: Apr. 30, 2026

(54) PROXY TRAFFIC OPTIMIZATION BY CACHING MEDIA RESOURCES

(71) Applicant: Oxylabs, UAB, Vilnius (LT)

(72) Inventor: Tadas GEDGAUDAS, Vilnius (LT)

(73) Assignee: Oxylabs, UAB, Vilnius (LT)

(21) Appl. No.: 18/930,741

(22) Filed: Oct. 29, 2024

(51) Int. Cl. G06F 12/0813; G06F 16/951

(52) U.S. Cl. CPC G06F 12/0813; G06F 16/951; G06F 2212/603

(57) ABSTRACT

Provided herein are system, apparatus, device, method and/or computer program product embodiments, and/or combinations and sub-combinations thereof, for caching media resources during a scraping operation. Web resources needed by webpage are stored in a cache that is used by multiple browsers that are scraping the webpage. When an unexpired entry for the web resource is present in the cache, a browser retrieves the web resource and cache instead of making a request from the webpage. This offers a technological improvement of reducing the traffic burden on proxy servers needed to forward the scraping requests and responses.

### BACKGROUND

### Field

This field is generally related to using machine learning to web scraping.

### Related Art

Web scraping (also known as screen scraping, data mining, web harvesting) is the automated gathering of data from the Internet. It is the practice of gathering data from the Internet through any means other than a human using a web browser. Web scraping is usually accomplished by executing a program that queries a web server and requests data automatically, then parses the data to extract the requested information.

To conduct web scraping, a program known as a web crawler may be used. A web crawler, sometimes called a web spider, is a program or an automated script which performs the first task, i.e. it navigates the web in an automated manner to retrieve data, such as Hypertext Transfer Markup Language (HTML) data, JSONs, XML, and binary files, of the accessed websites. Web scraping is useful for a variety of applications. In a first example, web scraping may be used for search engine optimization. In a second example, web scraping may be used to identify possible copyright. In a third example, web scraping may be useful to check placement of paid advertisements on a webpage. In a fourth example, web scraping may be useful to check prices or products listed on e-commerce websites.

Webpages are often documents hosted by a server, accessible by a web browser. Webpages are often structured using a markup language such as HyperText Markup Language (HTML). For example, a webpage may include any number of HTML elements defining components of the webpage. The HTML within the webpage may be structured according to a document object model (DOM). The DOM may be a tree structure used to logically organize components or sections of a webpage.

Webpages may refer to web resources that must be downloaded and perhaps executed to render the page. Such resources can include scripts, stylesheets, fonts, images, and video. Scripts include source code, such as JavaScript providing programmatic functionality to a page. For example, a webpage may reference JavaScript defining what happens when the button is clicked. A stylesheets includes style data defining how elements within the markup language should appear. For example, a webpage may include cascade style sheet (CSS) data indicating how elements appear.

To scrape pages, requests are often sent through a proxy server. Proxy servers generally act as intermediaries for requests from clients seeking content, services, and/or resources from target servers (e.g., web servers) on the Internet. For example, a client may connect to a proxy server to request data from another server. The proxy server evaluates the request and forwards the request to the other server containing the requested data. In the forwarded message, the source address may appear to the target to be not the client, but the proxy server. After obtaining the data, the proxy server forwards the data to the client. Depending on the type of request, the proxy server may have full visibility into the actual content fetched by the client, as is the case with an unencrypted Hypertext Transfer Protocol (HTTP) session. In other instances, the proxy server may blindly forward the data without being aware of what is being forwarded, as is the case with an encrypted Hypertext Transfer Protocol Secure (HTTPS) session.

To interact with a proxy server, the client may transmit data to the proxy server formatted according to a proxy protocol. The HTTP proxy protocol is one example of how the proxy protocol may operate. HTTP operates at the application layer of the network stack (layer 7). In another example, HTTP tunneling may be used, using, for example, the HTTP CONNECT command. In still another example, the proxy may use a SOCKS Internet protocol. While the HTTP proxy protocol operates at the application layer of the OSI (Open Systems Interconnection) model protocol stack, SOCKS may operate at the session layer (layer 5 of the OSI model protocol stack). Other protocols may be available forwarding data at different layers of the network protocol stack.

Transferring all the scraped data through the proxy server can consume a large amount of resources. Systems and methods are needed for more efficient web scraping.

### BRIEF SUMMARY

In an embodiment, a method caches web resources during a scraping operation. In the method, in response to a first request including a first address of a target webpage on the Internet, a first browser retrieves a first content located at the first address. The first content specifies a resource needed to assemble the target webpage located at a second address. The resource is retrieved from the Internet at the second address. Finally, the retrieved resource is stored in a file storage. In response to a second request including the first address of the target webpage, a second browser different from the first browser retrieves a second content located at the first address. It is determined whether the retrieved second content references the resource at the second address and the resource is stored unexpired in the file storage. When the resource is determined to be stored unexpired in the file storage, the resource is retrieved from the file storage to avoid needing to retrieve the resource from the Internet to assemble the target webpage.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF THE DRAWINGS

The accompanying drawings are incorporated herein and form a part of the specification.

FIG. 1 is a system for caching web resources for use by multiple web browsers, according to some embodiments.

FIG. 2 is a method for using a cache during web scraping, according to some embodiments.

FIG. 3 is a method for retrieving web scraping data from a cache, according to some embodiments.

FIG. 4 is a diagram illustrating an example document referencing web resources, according to some embodiments.

FIG. 5 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for caching media resources during a scraping operation. Web resources needed by webpage are stored in a cache that is used by multiple browsers that are scraping the webpage. When an unexpired entry for the web resource is present in the cache, a browser retrieves the web resource and cache instead of making a request from the webpage. This offers a technological improvement of reducing the traffic burden on proxy servers needed to forward the scraping requests and responses.

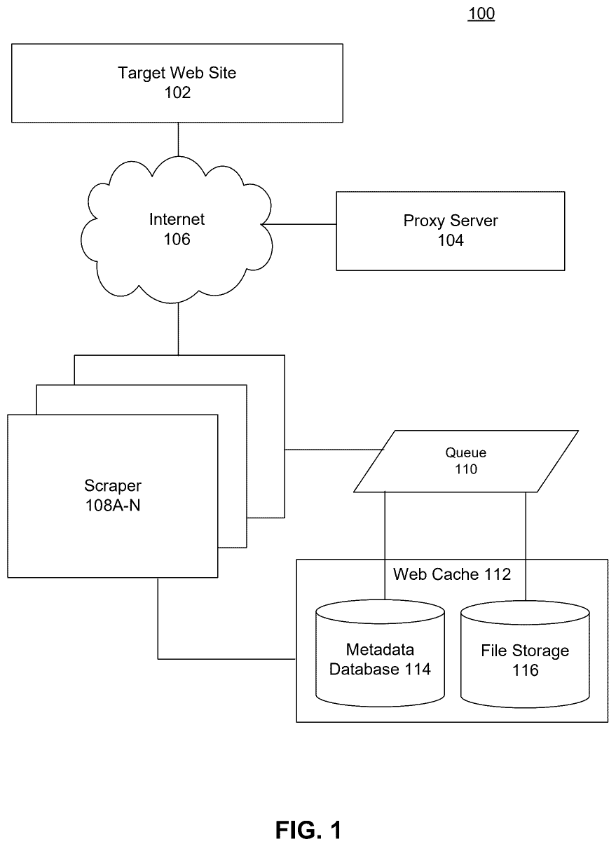

FIG. 1 is a block diagram illustrating system 100 for efficient caching and reuse of web resources during web scraping operations, according to some embodiments. System 100 may include a target web site 102, a proxy server 104, the Internet 106, a plurality of scrapers 108A-N, a queue 110, and a web cache 112 for caching web resources during scraping operations. Any operation herein may be performed by any type of structure in the diagram, such as a module or dedicated device, in hardware, software, or any combination thereof.

Target web site 102 may represent the destination website from which content and resources are to be scraped. This may be any website on the Internet that contains content of interest for scraping purposes. Target web site 102 may typically host HTML pages, scripts, stylesheets, images, and other web resources that could be retrieved and processed during the scraping operation. When a scraping request is initiated, the system 100 may attempt to access and retrieve content from the target web site 102, either directly or through the proxy server 104.

In some embodiments, target web site 102 may employ various techniques to avoid servicing automated requests, such as rate limiting, IP blocking, or CAPTCHAs. At least in part to make the traffic appear less automated, system 100 may utilize proxy server 104.

Proxy server 104 may act as an intermediary between the scrapers 108A-N and the target web site 102 via Internet 106. The proxy server 104 may provide additional security, anonymity, and traffic management capabilities. When a scraper 108A-N needs to access content from the target web site 102, the request may first be sent to the proxy server 104, which may then forward this request to the target web site 102 over Internet 106, masking the original IP address of the scraper. The response from target web site 102 may be also sent to the scraper 108A-N through the same proxy.

The use of proxy server 104 may provide several benefits in the context of web scraping. It may enable IP rotation, where the proxy server 104 can rotate IP addresses for outgoing requests, making it more difficult for target websites to detect and block scraping activity. By using proxy servers in different locations, the system may access geo-restricted content by appearing to be accessing the target web site 102 from various global locations.

In some embodiments, proxy server 104 may be a data center proxy, with an IP address assigned to a data center. In other embodiments, proxy server 104 may be implemented as a residential proxy assigned a residential or mobile IP address, which can provide additional benefits in terms of appearing as non-automated traffic to the target web site 102. In general, residential proxies may be scarcer and in greater demand, resulting in a greater cost as well. Additionally or alternatively, system 100 may employ a pool of proxy servers, allowing for even greater IP address diversity and improved load balancing. This pool could be dynamically managed, with proxy servers added or removed based on performance metrics and scraping demands.

Internet 106 is a wide area network that enables communication between the various components of system 100. In particular, Internet 106 may allow targets web site 102 to communicate with proxy server 104, and proxy server 104 to communicate with scrapers 108A-N. Internet 106 may utilize standard communication protocols such as TCP/IP to facilitate data transfer. Through Internet 106, scrapers 108A-N may be able to send requests to target web site 102, potentially routed through proxy server 104, to retrieve web content and resources. Similarly, Internet 106 may enable scrapers 108A-N to communicate with web cache 112 to store and retrieve cached web resources.

Scrapers 108A-N may represent one or more scraper instances that are configured to retrieve content from target web site 102 via Internet 106 and proxy server 104. Each scraper 108A-N may be implemented as a software application or script running on one or more computing devices. Scrapers 108A-N may be designed to send requests through proxy server 104 to target web site 102 to retrieve webpages and associated resources.

Each of scrapers 108A-N may be a headless browser. A headless browser is a web browser without a graphical user interface. Unlike traditional browsers the display content on the screen for users to interact with, headless browsers operate in the background, forming webpage loading and interactions programmatically. This allows developers to automate tasks like web scraping without needing to open a visible browser window. In one example, the Chrome DevTools Protocol (CDP) may be used to interact with the headless browsers programmatically.

When a scraper 108A-N receives a request to scrape content from a particular URL on target web site 102, it may first download the target page from target web site 102. The target page may reference a number of web resources. For each of the web resources, the scraper 108A-N may first check with web cache 112 to determine if the requested resources are already cached. If cached versions are available and not expired, the scraper 108A-N may retrieve the resources from file storage 116 via web cache 112, avoiding the need to download them again from the Internet.

If requested resources are not cached or have expired, the scraper 108A-N may proceed to retrieve them from target web site 102 through proxy server 104. As the scraper 108A-N receives the webpage content and associated resources (e.g. JavaScript files, CSS stylesheets, images), it may analyze them to identify additional resources that need to be retrieved.

The scraper 108A-N may then send requests to cache newly retrieved resources by placing them in queue 110. This may allow the resources to be stored in file storage 116 and have their metadata recorded in metadata database 114 for future use.

Queue 110 may serve as a task management system for handling requests to store resources within the web caching system 100. The queue 110 may receive storage requests from scrapers 108A-N when new web resources are retrieved during scraping operations. These storage requests may be placed in queue 110 to be stored asynchronously by the web cache 112. By utilizing a queue, the system may efficiently handle high volumes of storage requests without blocking or slowing down the scraping operations. Queue 110 may be implemented as a first-in-first-out (FIFO) data structure, ensuring that storage requests are processed in the order they are received. Additionally or alternatively, queue 110 may also prioritize certain types of requests, such as giving higher priority to frequently accessed resources or resources from specific domains.

Web cache 112 may be a component of system 100 for caching web resources during scraping operations. Web cache 112 may include metadata database 114 and file storage 116 for storing cached web resources and associated metadata. The metadata stored in database 114 may include information such as the resource file name (e.g., URL), associated domain, timestamp when cached, expiration time, and a reference to the stored resource file in file storage 116. This metadata may allow web cache 112 to efficiently determine if a cached resource is available and unexpired when handling subsequent scraping requests.

When a scraper 108 later requests a resource referenced from the same target web site 102, web cache 112 may check if referenced resources are available in its cache. For cached and unexpired resources, web cache 112 may serve the resource directly from file storage 116 rather than retrieving it again from the Internet. This may reduce bandwidth and proxy usage, and improve scraping performance.

Metadata database 114 may store metadata associated with cached web resources. This metadata database 114 may be implemented as a relational database, NoSQL database, or other suitable data storage system. Metadata stored in database 114 may include information such as the URL or identifier of the cached resource, the domain the resource was retrieved from, the date/time the resource was originally cached, an expiration date/time for when the cached resource should be invalidated, and the full filename of the cached resource including file extension.

The metadata in database 114 may allow the system to track what resources have been cached, when they were cached, and when they need to expire. This may enable efficient lookup and management of cached resources.

File storage 116 may be a file system or other data storage mechanism for storing cached web resources retrieved during scraping operations. File storage 116 may be part of web cache 112 and may work in conjunction with metadata database 114 to provide efficient caching and retrieval of web resources.

When a scraper 108A-N retrieves a resource such as a JavaScript file, CSS stylesheet, image, or other asset from a target web site 102 during scraping, that resource may be stored in file storage 116. The metadata about the stored resource, such as its URL, domain, expiration time, and filename, may be recorded in metadata database 114.

File storage 116 may allow the system to avoid repeatedly downloading the same resources from target web sites. When a scraper needs a particular resource, it may first check if that resource is available in file storage 116 by querying the metadata database 114. If the resource is cached and not expired, it may be retrieved directly from file storage 116 rather than downloading it again from the Internet.

This caching in file storage 116 may provide several benefits, including reduced bandwidth usage and costs, especially for residential proxy traffic and faster scraping operations since cached resources can be retrieved more quickly.

By caching and reusing web resources across multiple scraping operations, system 100 may significantly reduce bandwidth usage, particularly when using residential proxy servers, and improve the speed and efficiency of large-scale web scraping tasks. The system may provide a centralized caching architecture that can be leveraged by multiple distributed scraping processes.

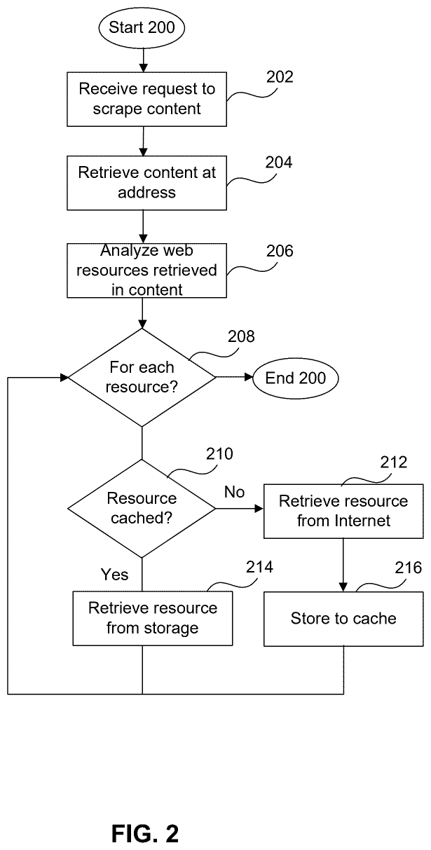

FIG. 2 is a flowchart illustrating a method 200 for efficiently scraping web content while utilizing a caching system to reduce unnecessary network traffic and improve performance. Method 200 shall be described with reference to FIG. 1. However, method 200 is not limited to that example embodiment. It is to be appreciated that not all steps may be needed to perform the disclosure provided herein. Further, some of the steps may be performed simultaneously, or in a different order than shown in FIG. 2, as will be understood by a person of ordinary skill in the art.

The method may begin at step 202 where a request may be received to scrape content from a target webpage. This request may come from a user, application, or automated system seeking to extract data from a particular webpage.

At step 202, the system may receive various types of scraping requests. For example, one of scrapers 108A-N may receive a request from a user or automated process to retrieve and parse content from target web site 102. The request may specify a URL or other address for the target webpage to be scraped. The scraper 108A-N receiving the request may initiate the scraping process by preparing to retrieve the specified webpage content, typically through proxy server 104 to access target web site 102 via Internet 106.

At step 204, the content located at the address specified in the scraping request may be retrieved. This typically may involve sending an HTTP request to the target web server 102 and receiving the HTML content of the page in response. Specifically, a scraper 108A-N may retrieve content from a target web site 102 at a particular URL address provided in the scrape request. This content retrieval may occur through the proxy server 104 and over Internet 106. The retrieved content typically may include the HTML document for the requested webpage, which may reference various web resources needed to fully render the page. These web resources can include stylesheets, JavaScript files, images, fonts, and other assets that are specified within the HTML document.

In some embodiments, step 204 may be implemented in a headless browser that renders the page and execute any JavaScript, ensuring that dynamically generated content may be captured. To that end, in step 206, the retrieved web content may be analyzed to identify any embedded resources that are required to fully render the page. This analysis may involve parsing the HTML content to identify tags or elements that reference external resources such as stylesheet links, script tags, image tags, font files, or other embedded resources.

The analysis in step 206 may employ various techniques to thoroughly identify all resources. For instance, it may use CDP commands to instruct the scraper to notify a software module whenever a web resource is requested. In other embodiments, it might use regular expressions or a document object model to parse the HTML and extract resource URLs. An example of web content that can be retrieved in step 204 and analyzed in step 206 to determine what web resources it refers to.

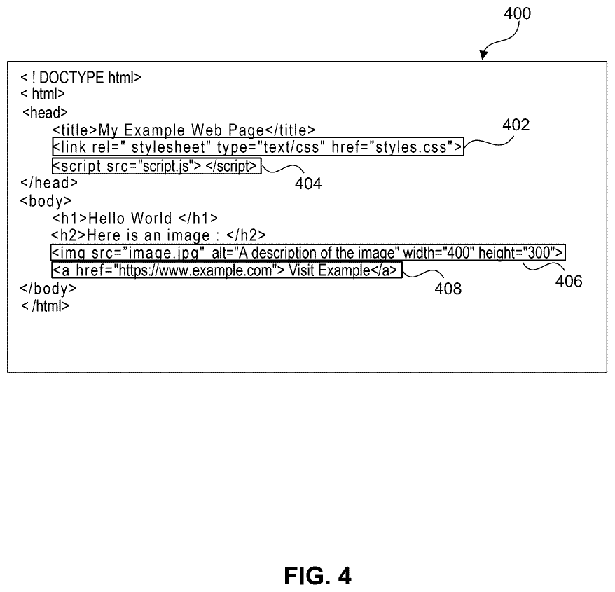

FIG. 4 may illustrate an example HTML document structure 400 that demonstrates how webpages typically reference and incorporate various types of external resources. The document may begin with the standard HTML5 DOCTYPE declaration and could contain the basic HTML, head, and body elements. Within the head section, there may be two important resource references:

A stylesheet link 402 may be included as an HTML link element that references an external CSS (Cascading Style Sheet) file named “styles.css”. The link element may include attributes such as rel=“stylesheet”, type=“text/css”, and href=“styles.css”. When a web browser renders HTML document 400, it may retrieve and apply the styles defined in the referenced CSS file to format and style the content of the document. In the context of the scraping system 100, the stylesheet link 402 may enable identification and potential caching of the CSS resource separately from the main HTML content.

A script tag 404 may be present, referencing and including an external JavaScript file named “script.js”. The script tag 404 may have a “src” attribute set to “script.js”, indicating that it loads this external JavaScript file. Placing the script tag 404 within the <head> section could be a common practice for including scripts that need to be loaded before the main body content is rendered. In the context of the invention, the script tag 404 may represent another type of web resource that could be cached and managed by the system described in FIG. 1.

The body section of HTML document 400 may contain some basic content, including headings and an image. Image tag 406 references another web resource that is needed to render the page—“image.jpg”.

Anchor tag 408 creates a hyperlink to “https://www.example.com” when text is clicked. Notably, even though page 400 includes a reference to “https://www.example.com,” this may not be identified as a web resource that requested by the page in step 206, because the content at “https://www.example.com” is not needed to render HTML document 400.

In this way, HTML structure 400 may illustrate how webpages commonly reference and incorporate various types of external resources, such as stylesheets (CSS), scripts (JavaScript), and images. These resources could be prime candidates for caching in the web resource caching system described in this patent, as they are often reused across multiple pages or requests to the same site.

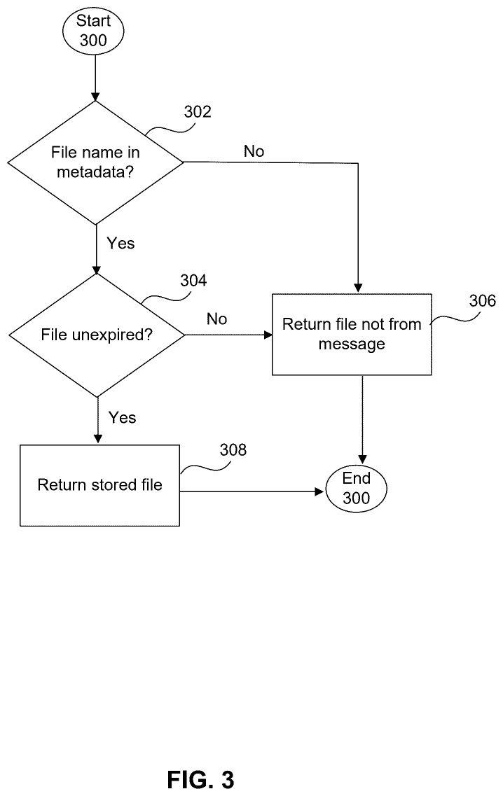

Returning to FIG. 2, step 208 may initiate a loop to process each resource identified in step 206. Returning to the example in FIG. 4, this loop may be repeated for each of stylesheet link 402 (“styles.css”), script tag 404 (“script.js”), and image tag 406 (“image.jpg”). For each resource, the method may proceed to decision block 210 to determine if the resource is already cached in the system's storage. This may involve checking a metadata database 114 to see if an unexpired version of the resource exists in the cache, as is illustrated in FIG. 3.

If the resource is not cached, the method may proceed to step 212 where the resource may be retrieved from its original location on the Internet, typically through proxy server 104. Once retrieved, the resource may be stored in the cache at step 216, which may involve saving the file to file storage 116 and updating metadata in database 114, possibly through a queue 110 as described with respect to FIG. 1.

If the resource is found to be cached at step 210, the method may proceed directly to step 214 where the resource may be retrieved from the local storage system rather than from the Internet.

This method 200 may allow for significant optimization of the scraping process by reducing redundant downloads of static resources across multiple scraping operations. By intelligently caching and reusing resources, the system can minimize its reliance on proxy servers 104 and external network requests, leading to faster scraping times and reduced bandwidth usage.

FIG. 3 is a flowchart illustrating a method 300 for efficiently retrieving cached web resources during a scraping operation, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 1. However, method 300 is not limited to that example embodiment.

In some embodiments, the steps of method 300 may be performed by components of the web cache 112, including the metadata database 114 and file storage 116, or some combination thereof. While method 300 may be discussed as being performed by these components, other components may store code necessary to execute some or all of the steps of method 300.

The method 300 may begin at the start block and proceed to decision block 302. At decision block 302, a determination may be made whether a file name for a requested resource is present in metadata stored in metadata database 114. This metadata may include information such as the domain, date the file was uploaded, expiration date, and full file name for cached resources. The file name may act as an identifier for cached resources that have previously been retrieved and stored in file storage 116.

When a request is received from scrapers 108A-N to retrieve a web resource, the method 300 may begin by checking if metadata for that resource exists. Specifically, decision block 302 may query the metadata database 114 to see if a file name matching the requested resource is stored. By first checking for the existence of metadata about a requested resource, decision block 302 may allow the system 100 to quickly determine if a resource may be available in the cache without needing to access the actual file storage 116. This may improve efficiency, especially for resources that have not been previously cached. The metadata check may act as an initial filter before proceeding with further cache retrieval steps.

In some embodiments, the metadata database 114 may use a hash table or other efficient data structure to store and retrieve file names quickly. This can further optimize the lookup process, especially when dealing with a large number of cached resources.

If the file name is not found in the metadata, the method may proceed to step 306 where a “file not found” message may be returned to the requesting scraper 108A-N, indicating the resource is not available in the cache. This may occur when the resource has never been cached before.

If the file name is found in the metadata, the method may continue to decision block 304. At decision block 304, a check may be performed to determine if the cached file is unexpired based on the expiration date stored in the metadata. This expiration date may be configured by the user, with a default such as 24 hours after the file was originally cached.

The expiration check in decision block 304 may enable the system 100 to ensure that only up-to-date cached resources are served to scrapers 108A-N. This may help maintain data freshness while still allowing cached resources to be used when valid. The expiration time for cached files may be configurable, for example defaulting to 24 hours from when the file was originally cached, but adjustable based on the needs of particular scraping operations or target websites 102.

By implementing this expiration check, the system 100 may balance the benefits of caching web resources with the need to periodically refresh cached data. This may allow scraping operations to benefit from reduced bandwidth usage and improved performance when using cached resources, while still ensuring that excessively stale data is not served from the cache.

If the file is determined to be expired at block 304, the method may proceed to step 306 to return a “file not found” message to the requesting scraper 108A-N, as the expired resource should not be used. This “file not found” message may serve as a signal to the scraper or other requesting entity that it needs to retrieve the resource from the original source on Internet 106, rather than relying on the cached copy.

If the file is unexpired, the method may continue to step 308. At step 308, the stored file may be retrieved from file storage 116 and returned to fulfill the resource request from the scraper 108A-N. After determining that the file name is in the metadata database 114 and that the file is unexpired, the method 300 may proceed to retrieve and return the stored file from file storage 116 within web cache 112. This may allow the scraper 108A-N to access the cached resource without needing to download it again from the target web site 102 over Internet 106.

By serving the cached file, network traffic and scraping time may be reduced. The cached file may be returned to fulfill the original scraping request, allowing assembly of the target webpage to proceed using the locally stored resource rather than retrieving it remotely.

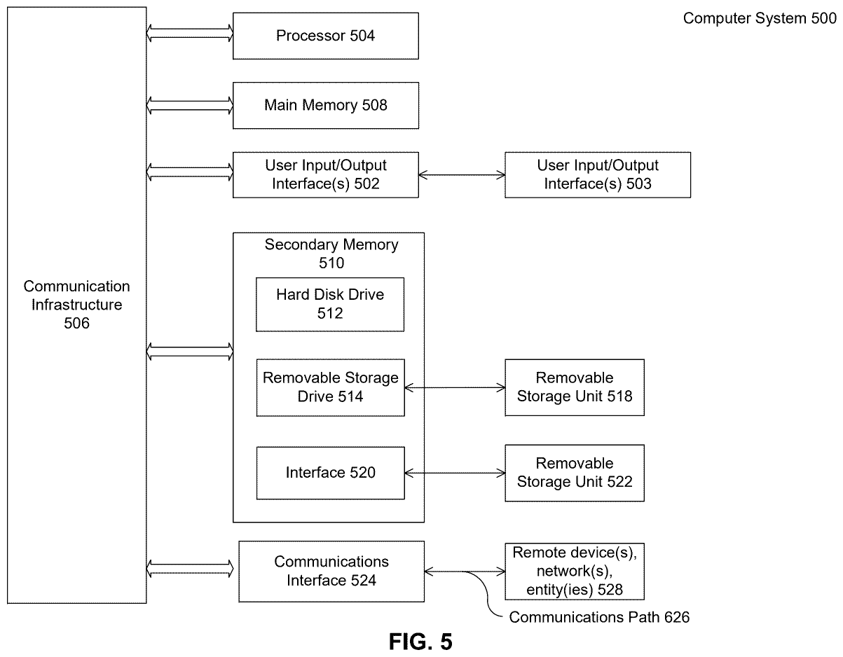

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

A method for caching web resources during a scraping operation is presented, comprising:
in response to a first request to scrape, the first request comprising a first address of a target webpage on the Internet:
   (a) by a first browser, retrieving a first content located at the first address, wherein the first content specifies a resource located at a second address, the resource needed to assemble the target webpage;
   (b) by the first browser, retrieving the resource from the Internet at the second address;
   (c) storing the retrieved resource in a file storage;
   in response to a second request to scrape, the second request comprising the first address of the target webpage on the Internet:
   (d) by a second browser different from the first browser, retrieving a second content located at the first address;
   (e) by the first or the second browser, determining whether the retrieved second content references the resource at the second address and the resource is stored unexpired in the file storage;
   (f) when the resource is determined to be stored unexpired in the file storage, retrieving the resource from the file storage to avoid needing to retrieve the resource from the Internet to assemble the target webpage.

The method is presented, wherein the determining (e) comprises determining that the retrieved second content refers to a file name stored for the resource in the file storage.

The method is presented, wherein the first request specified by a first client wherein the determining (e) comprises determining whether a time period associated with the first client has elapsed since the resource was retrieved in (b).

The method is presented, wherein the first request specified by a first client wherein the determining (e) comprises determining whether a time period associated with the first client has elapsed since the resource was retrieved in (b).

The method is presented, further comprising, when the time frame is expired:
(g) re-retrieving the resource from the Internet at the second address to assemble the target webpage; and
(h) storing the re-retrieved resource in the file storage.

The method is presented, wherein the determining (e) comprises the retrieved second content references another resource not stored in the file storage,
(g) retrieving the other resource from the Internet to assemble the target webpage; and
(h) storing the other resource in the file storage.

The method is presented, wherein the resource is at least one of javascript, a stylesheets, a font, an image, or a video file.

The method is presented, wherein the retrieving (a) and the retrieving (a) each occur through a proxy server.

The method is presented, wherein the retrieving (a) and the retrieving (a) each occur through a residential proxy server.

The method is presented, wherein the storing (c) comprises placing a request to store the retrieved resource in a queue for storage in the file storage.

A non-transitory computer-readable storage medium is presented with instructions which, when executed by a computer device, causes the computer device to:
in response to a first request to scrape, the first request comprising a first address of a target webpage on the Internet:
   (a) by a first browser, retrieving a first content located at the first address, wherein the first content specifies a resource located at a second address, the resource needed to assemble the target webpage;
   (b) by the first browser, retrieving the resource from the Internet at the second address;
   (c) storing the retrieved resource in a file storage;
in response to a second request to scrape, the second request comprising the first address of the target webpage:
   (d) by a second browser different from the first browser, retrieving a second content located at the first address;
   (e) determining whether the retrieved second content references the resource at the second address and the resource is stored unexpired in the file storage;
   (f) when the resource is determined to be stored unexpired in the file storage, retrieving the resource from the file storage to avoid needing to retrieve the resource from the Internet to assemble the target webpage.

The non-transitory computer-readable storage medium is presented, wherein the determining (e) comprises determining that the retrieved second content refers to a file name stored for the resource in the file storage.

The non-transitory computer-readable storage medium is presented, wherein the first request specified by a first client wherein the determining (e) comprises determining whether a time period associated with the first client has elapsed since the resource was retrieved in (b).

The non-transitory computer-readable storage medium is presented, wherein the first request specified by a first client wherein the determining (e) comprises determining whether a time period associated with the first client has elapsed since the resource was retrieved in (b).

The non-transitory computer-readable storage medium is presented, further comprising, when the time frame is expired:
(g) re-retrieving the resource from the Internet at the second address to assemble the target webpage; and
(h) storing the re-retrieved resource in the file storage.

The non-transitory computer-readable storage medium is presented, wherein the determining (e) comprises the retrieved second content references another resource not stored in the file storage,
(g) retrieving the other resource from the Internet to assemble the target webpage; and
(h) storing the other resource in the file storage.

The non-transitory computer-readable storage medium is presented, wherein the resource is at least one of javascript, a stylesheets, a font, an image, or a video file.

The non-transitory computer-readable storage medium is presented, wherein the retrieving (a) and the retrieving (a) each occur through a proxy server.

The non-transitory computer-readable storage medium is presented, wherein the retrieving (a) and the retrieving (a) each occur through a residential proxy server.

The non-transitory computer-readable storage medium is presented, wherein the storing (c) comprises placing a request to store the retrieved resource in a queue for storage in the file storage.

Identifiers, such as “(a),” “(b),” “(i),” “(ii),” etc., are sometimes used for different elements or steps. These identifiers are used for clarity and do not necessarily designate an order for the elements or steps.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method for caching web resources during a scraping operation, comprising:
in response to a first request to scrape, the first request comprising a first address of a target webpage on the Internet:
(a) by a first browser, retrieving a first content located at the first address, wherein the first content specifies a resource located at a second address, the resource needed to assemble the target webpage;
(b) by the first browser, retrieving the resource from the Internet at the second address; and
(c) storing the retrieved resource in a local file storage; and
in response to a second request from a client device to scrape, the second request comprising the first address of the target webpage on the Internet:
(d) by a second browser different from the first browser, retrieving a second content located at the first address;
(e) by the first or the second browser, determining whether the retrieved second content references the resource at the second address based on the retrieved second content comprising a file name associated with the resource;
(f) querying a local metadata database based on the file name to retrieve metadata associated with the resource, wherein the metadata indicated that the resource exists in the local file storage;
(g) determining, based on the metadata, whether the resource is stored unexpired in the local file storage;
(h) when the resource is determined to be stored unexpired in the local file storage, retrieving the resource from the local file storage to avoid needing to retrieve the resource from the Internet to assemble the target webpage; and
(i) transmitting the resource to the client device.

2. The method of claim 1, wherein the determining (e) comprises determining that the retrieved second content refers to a file name stored for the resource in the local file storage.

3. (canceled)

4. The method of claim 1, wherein the first request is specified by a first client and wherein the determining (g) comprises determining whether a time period associated with the first client has elapsed since the resource was retrieved in (b).

5. The method of claim 4, further comprising, when the time frame is expired:
(j) re-retrieving the resource from the Internet at the second address to assemble the target webpage; and
(k) storing the re-retrieved resource in the local file storage.

6. The method of claim 1, wherein the querying (f) comprises the retrieved second content references another resource not stored in the local file storage,
(j) retrieving the other resource from the Internet to assemble the target webpage; and
(k) storing the other resource in the local file storage.

7. The method of claim 1, wherein the resource is at least one of javascript, a stylesheets, a font, an image, or a video file.

8. The method of claim 1, wherein the retrieving (a) and the retrieving (d) each occur through a proxy server.

9. The method of claim 1, wherein the retrieving (a) and the retrieving (d) each occur through a residential proxy server.

10. The method of claim 1, wherein the storing (c) comprises placing a request to store the retrieved resource in a queue for storage in the local file storage.

11. A non-transitory computer-readable storage medium with instructions stored thereon which, when executed by a computer device, causes the computer device to:
in response to a first request to scrape, the first request comprising a first address of a target webpage on the Internet:
(a) by a first browser, retrieving a first content located at the first address, wherein the first content specifies a resource located at a second address, the resource needed to assemble the target webpage;
(b) by the first browser, retrieving the resource from the Internet at the second address; and
(c) storing the retrieved resource in a local file storage; and
in response to a second request from a client device to scrape, the second request comprising the first address of the target webpage:
(d) by a second browser different from the first browser, retrieving a second content located at the first address;
(e) determining whether the retrieved second content references the resource at the second address based on the retrieved second content comprising a file name associated with the resource;
(f) querying a local metadata database based on the file name to retrieve metadata associated with the resource, wherein the metadata indicated that the resource exists in the local file storage;
(g) determining, based on the metadata, whether the resource is stored unexpired in the local file storage;
(h) when the resource is determined to be stored unexpired in the local file storage, retrieving the resource from the local file storage to avoid needing to retrieve the resource from the Internet to assemble the target webpage; and
(i) transmitting the resource to the client device.

12. The non-transitory computer-readable storage medium of claim 11, wherein the determining (e) comprises determining that the retrieved second content refers to a file name stored for the resource in the local file storage.

13. (canceled)

14. The non-transitory computer-readable storage medium of claim 11, wherein the first request is specified by a first client and wherein the determining (g) comprises determining whether a time period associated with the first client has elapsed since the resource was retrieved in (b).

15. The non-transitory computer-readable storage medium of claim 14, further comprising, when the time frame is expired:
(j) re-retrieving the resource from the Internet at the second address to assemble the target webpage; and
(k) storing the re-retrieved resource in the local file storage.

16. The non-transitory computer-readable storage medium of claim 11, wherein the querying (f) comprises the retrieved second content references another resource not stored in the local file storage,
(j) retrieving the other resource from the Internet to assemble the target webpage; and
(k) storing the other resource in the local file storage.

17. The non-transitory computer-readable storage medium of claim 11, wherein the resource is at least one of javascript, a stylesheets, a font, an image, or a video file.

18. The non-transitory computer-readable storage medium of claim 11, wherein the retrieving (a) and the retrieving (d) each occur through a proxy server.

19. The non-transitory computer-readable storage medium of claim 11, wherein the retrieving (a) and the retrieving (d) each occur through a residential proxy server.

20. The non-transitory computer-readable storage medium of claim 11, wherein the storing (c) comprises placing a request to store the retrieved resource in a queue for storage in the local file storage.
